(19) United States
(12) Patent Application Publication
(10) Pub. No.: US 2006/0097042 A1
(43) Pub. Date: May 11, 2006

(54) System and method for creating shopping lists

(76) Inventor: Linda Susan Kincaid, Jackson, OH (US)

Correspondence Address: Porter, Wright, Morris & Arthur LLP;ATTN: Intellectual Property Department, 28th Floor, 41 South High Street, Columbus, OH, 43215-6194, US

(21) Appl. No.: 10/983,252

(22) Filed: Nov. 5, 2004

(51) Int. Cl. G06K 15/00

(52) U.S. Cl. 235/383

(57) ABSTRACT

A method for creating a shopping list includes a product package having a release layer and an identification label with a layer of adhesive adhered to the release layer to removably secure the identification label to the product package. The identification label has product identification information such as a brand name, a brand logo, a product name, a product location, a product identification number, a bar code and/or a savings coupon. A consumer obtains the product package, removes the identification label from the release layer, adheres the identification label to a shopping list to form a list of products to purchase, goes to a store to obtain an additional product package, and uses the identification label adhered to the shopping list to locate the additional product package within the store.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to systems and methods for creating shopping lists and, more particularly, to such systems and methods which incorporate product packaging.

### BACKGROUND OF THE INVENTION

Many grocery shoppers go to the store with a shopping list. However, creating a shopping list can be very time consuming and consumers often fail to write down items that they need to purchase. Additionally, once at the grocery store, consumers often consume time looking for products among the various aisles and shelves and trying to determine which exact product they typically purchase because of the increasing large number of options available which can all look alike on the shelf. Particularly these shoppers who do not make regular shopping visits.

Accordingly, there is a need in the art for improved systems and methods for creating shopping lists.

### SUMMARY OF THE INVENTION

The present invention provides systems and methods for creating shopping lists which overcome at least some of the above-noted problems of the related art. According to the present invention, a method for creating a shopping list comprising the steps of providing a product package with a release layer and providing an identification label having a layer of adhesive adhered to the release layer to removably secure the identification label to the product package. The identification label is provided with product identification information including a brand name and a product identification number. Whereby a consumer can remove the identification label from the release layer and adhere the identification label to a shopping list to form a list of products to purchase.

According to another aspect of the present invention, a method for creating a shopping list comprising the steps of providing a product package with a release layer and providing an identification label having a layer of adhesive adhered to the release layer to removably secure the identification label to the product package. The identification label is provided with product identification information including a brand name and a savings coupon. Whereby a consumer can remove the identification label from the release layer and adhere the identification label to a shopping list to form a list of products to purchase and use the savings coupon for purchase price savings at purchase.

According to yet another aspect of the present invention, a method for creating a shopping list comprising the steps of providing a product package, providing a release layer secured to a surface of the product package, and providing an identification label having a layer of adhesive adhered to the release layer to removably secure the identification label to the product package. The identification label is provided with product identification information including a brand logo, a brand name, a product name, a product identification number, and a savings coupon. Whereby a consumer can remove the identification label from the release layer and adhere the identification label to a shopping list to form a list of products to purchase and use the savings coupon for purchase price savings at purchase.

From the foregoing disclosure and the following more detailed description of various preferred embodiments it will be apparent to those skilled in the art that the present invention provides a significant advance in the technology of shopping lists. Particularly significant in this regard is the potential the invention affords for providing a high quality, reliable, simple, and relatively low cost system and method. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is an orthogonal view of an identification label according to a preferred embodiment of the present invention;

FIG. 2 is a side orthogonal view of the identification label of FIG. 1;

FIG. 3A is an isometric view of a first consumer product incorporating the identification label of FIG. 1;

FIG. 3B is an isometric view of a second consumer product incorporating an identification similar to the identification label of FIG. 1;

FIG. 3C is an isometric view of a third consumer product incorporating an identification label similar to the identification label of FIG. 1;

FIG. 3D is an isometric view of a fourth consumer product incorporating an identification label similar to the identification label of FIG. 1;

FIG. 4 is an orthogonal view of an alternative identification label similar to the identification label of FIG. 1 but wherein the identification label includes a savings coupon;

FIG. 5 is an orthogonal view of a shipping list for use with the identification labels of FIGS. 1 and 4; and

FIG. 6 is an orthogonal view of an alternative shipping list for use with the identification labels of FIGS. 1 and 4.

It should be understood that the appended drawings are not necessarily to scale, presenting a somewhat simplified representation of various preferred features illustrative of the basic principles of the invention. The specific design features of the shopping list method and system as disclosed herein, including, for example, specific materials, dimensions, orientations, and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved shopping list systems and methods disclosed herein. The following detailed discussion of various alternative and preferred embodiments will illustrate the general principles of the invention. Other embodiments suitable for other applications will be apparent to those skilled in the art given the benefit of this disclosure.

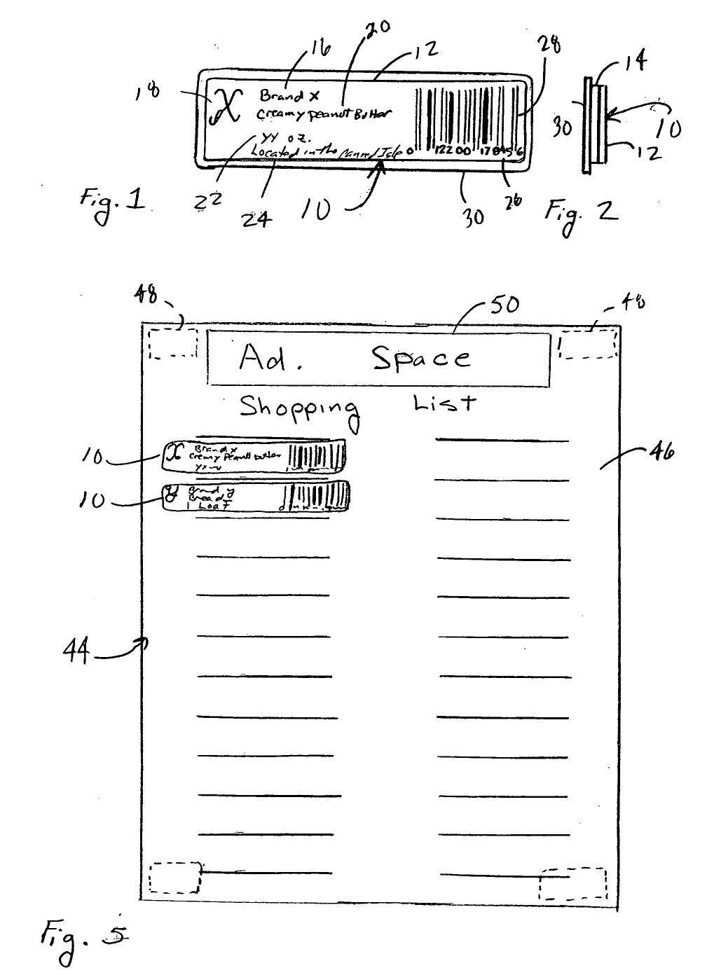

Referring now to the drawings, FIGS. 1 and 2 shows an identification label 10 according to the present invention. The illustrated identification label includes a main layer 12 and an adhesive layer 14 secured to the rear side of the main body 12. The main body 12 is preferably formed of a relatively thin, flexible sheet of paper, plastic or other suitable material. It is noted that while the main body 12 is preferably constructed of a single layer of material, the main layer can alternatively comprise more than one layer of material. The front surface of the main body 12 is provided with suitable identification information for identifying a desired consumer product. The illustrated identification information includes a brand name 16 for the product, a brand logo 18 for the product, a name or description 20 of the product, a size 22 of the product, a location 24 where the product is typically located in a store such as a grocery store, a identification number 26 for the product, and a bar code 28 representing the identification number 26. The illustrated identification number 26 is a Uniform Product Code (UPC) number but it is noted that the identification number 26 can be any other suitable number such as, for example, EAN, JAN, GTIN, stock keeping unit (SKU) or any other suitable number which is a unique identifier for the product. The identification information is provided on the outer surface of the main body 12 in any suitable manner such as printing.

The adhesive layer 14 is secured to the inner surface of the main body 12. The adhesive layer 14 preferably comprises a pressure-sensitive adhesive but any other suitable adhesive can be utilized. The illustrated adhesive layer 14 is removably adhered to a release film or layer 30 on the product so that the identification label 10 can be removed from the release layer 30 and permanently secured at a desired location. The release layer 30 is preferably formed of a relatively thin, flexible sheet of paper, plastic or other suitable material such as the release layers upon which unused labels and stickers are typically sold. The front surface of the release layer 30 has a suitable release surface such that the adhesive layer 14 is easily removable therefrom by peeling. That is, the main body 12, along with the adhesive layer 14, can be easily peeled or pried from the release layer 30 when desired so that the main body 12 and the adhesive layer 14 can be adhered to a desired location. It is noted that the release layer 30 enables the adhesive layer 14 to be of a suitable type to permanently secure the identification label 10 when applied to a non-release surface such as, for example, a sheet of notebook paper

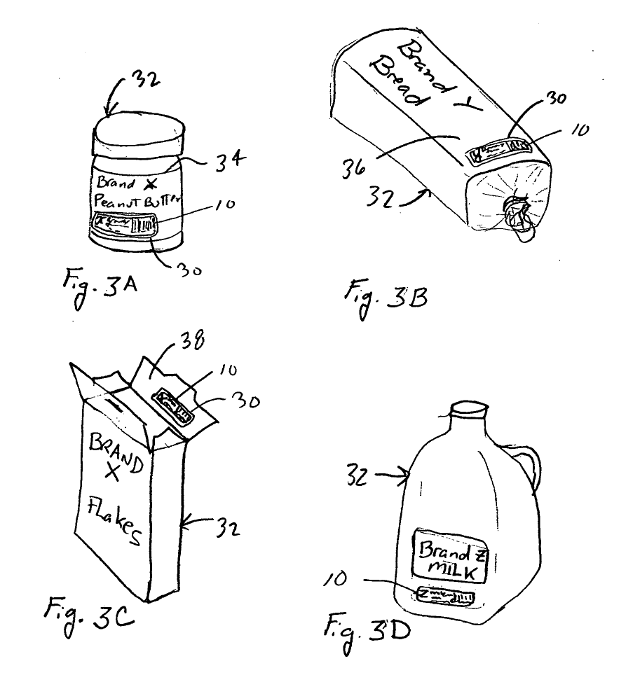

As best shown in FIG. 3A, the release layer 30 is securely affixed to a desired consumer product packaging 32. The release layer 30 can be secured in any suitable manner such as, for example, adhesive. The release layer 30 is secured to the product packaging 32 in a manner such that the identification label 10 can be easily pried from the release layer 30 without removing the release layer 30 from the product packaging 32. It is noted that that the release layer 30 can be eliminated if the product packaging 32 otherwise provides a suitable release surface for the identification label 10 (best shown in FIG. 3D).

FIGS. 3A to 3D illustrate that the identification label 10 can be secured to any suitable product packaging 32 for a consumer product such as, for example, peanut butter, bread, cereal, or milk. It is noted that the identification labels 10 can be secured to not only food products but also to any other desirable consumer product, particularly those typically sold in grocery stores such as, for example, beverage, health care, cleaning, laundry, paper and trash, bath and beauty products. FIGS. 3A to 3D also illustrate that the release layer 30 can be located and/or secured at any suitable location on the product packaging 32 such as, for example, an exterior product label 34 (FIG. 3A), on an exterior surface 36 (FIG. 3B), an interior surface 38 (FIG. 3C).

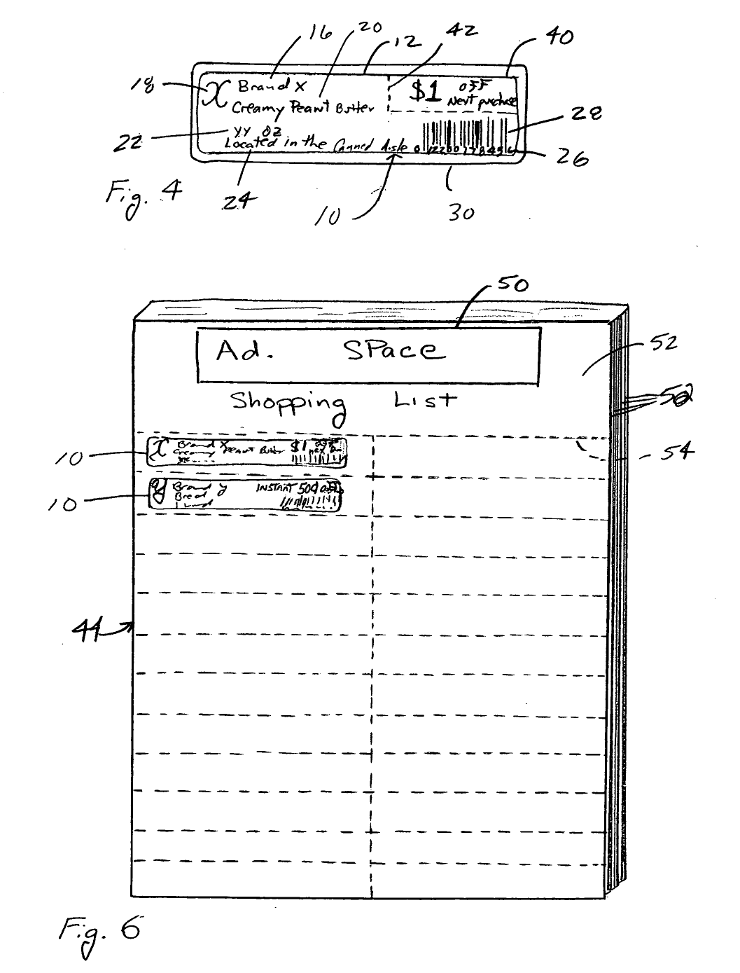

FIG.4 shows an alternative embodiment of the identification label 10 wherein the identification label 10 further includes a savings coupon 40. The savings coupon 40 provides information with allows the consumer to receive a predetermined amount of savings from the purchase price. The savings coupon 40 can indicate that the savings are instant, that is the savings can be applied toward the purchase price of the consumer product to which the coupon 40 is attached, or future, that is the savings can be applied toward the purchase of the next identical or similar consumer product. The inclusion of a bar code 28 can enable a cashier to electronically scan the savings coupon 40. It is noted that for instant coupons 40, the identification label 10 is preferably provided with perforations 42 or other suitable means for removing the coupon 40 so that the remainder of the identification label 10 can be maintained by the consumer for use as described hereinafter.

FIG. 5 shows a shopping list 44 according to a preferred embodiment of the present invention. The shopping list 44 has a relatively smooth and flat release surface 46 to which a plurality of the identification labels 10 can be adhered to create a list of items to be purchased. The release surface 46 enables the user to remove the identification labels 10 upon the purchase of the item so that the shopping list can be reused over and over. It is noted that the shopping list 44 can be formed of any suitable materials and in any suitable manner. The release surface 46 is preferably a surface which can be marked with “dry-erase” markers so that items not having identification labels 10 can be written onto to the shopping list 44 and easily removed for reuse of the shopping list 44. The illustrated shopping list 44 is provided with magnets 48 so that the shopping list 44 can be releasably secured to a refrigerator or other suitable surface. The illustrated shopping list 44 is also provided with an advertisement 50 which can advantageously be either a manufacturer or retailer of the consumer products.

FIG. 6 shows an alternative embodiment of the shopping list 44 wherein the shopping list comprises a plurality of sheets of paper 52 such as a note pad. In this embodiment, the sheets 52 are disposable so that the identification labels 10 do not need to be removed from the sheets 52. Also, the sheets 52 can be easily marked with standard pens or pencils so that items not having identification labels 10 can be written onto to the shopping list 44. The illustrated sheets 52 are provided with perforations 54 so that the identification labels 10 can be removed to use any coupons 40 included thereon. Alternatively, the sheets 52 can be provided with a release surface so that the identification labels 10 can be easily removed to use any coupons 40 thereon. If is noted that any other suitable shopping list 44 such as, for example, a standard sheet of notebook paper can be utilized with to collect and secure the identification labels 10.

As a consumer uses products and replacement products are needed, the consumer removes the identification labels 10 from the product packages 32 by prying the identification labels 10 from the release layers 30 and adheres the identification labels 10 to the shopping list 44. When it is time to go shopping, the consumer can take the shopping list 44 with the identification labels 10 adhered thereto. During shopping, the consumer has reference to each of the specific products that needs to be purchased including product brand 16, name or description 20, size 22, location 24, and identification number 26. This information enables the consumer to purchase the specific product that they find desirable even when there are many similar packages, even similar packages offered by the same brand. As the consumer is checking out the products, any identification labels 10 having coupons 40 thereon can be redeemed for savings against the purchase price. After shopping is complete, the consumer can either clean the shopping list 44 to start again if it is reusable, or dispose of the shopping list 44 and begin using a new sheet 52 if it is disposable. It is also noted that the shopping list 44 can be used to order groceries at the grocery store or other service which collects the desired products for the consumer. The inclusion of the bar codes 28 on the identification labels 10 can enable the labels 10 to be electronically scanned to create an electronic shopping or item list for this purpose.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. A method for creating a shopping list comprising steps of:
providing a product package with a release layer;
providing an identification label having a layer of adhesive adhered to the release layer to removably secure the identification label to the product package;
providing the identification label with product identification information including a brand name and a product identification number;
providing the identification label with a product location within a store where the product package can be located within the store; and
whereby a consumer obtains the product package, removes the identification label from the release layer, adheres the identification label to a shopping list to form a list of products to purchase, goes to the store to obtain an additional product package, and locates the additional product package at the location within the store identified on the identification label adhered to the shopping list.

2. The method according to claim 1, further comprising the step of providing the identification label with a brand logo.

3. The method according to claim 1, wherein the step of providing the identification label with a product location within a store includes identifying an aisle within the store.

4. The method according to claim 1, further comprising the step of providing the identification label with a bar code representing the product identification number.

5. The method according to claim 1, further comprising the step of providing the identification label with a product name.

6. The method according to claim 1, further comprising the step of providing the release layer secured to an outside surface of the product package.

7. The method according to claim 1, further comprising the step of providing the release layer secured to an inside surface of the product package.

8. The method according to claim 1, further comprising the step of providing the identification label with a savings coupon.

9. The method according to claim 8, further comprising the step of providing the savings coupon with perforations for separating the savings coupon from the identification label.

10. A method for creating a shopping list comprising steps of:
providing a product package with a release layer;
providing an identification label having a layer of adhesive adhered to the release layer to removably secure the identification label to the product package;
providing the identification label with product identification information including a bar code representing a product identification number; and
whereby a consumer obtains the product package, removes the identification label from the release layers, adheres the identification label to a shopping list to form a list of products to purchase, and electronically scans the bar code on the identification label adhered to the shopping list to create an electronic shopping list for an additional product package.

11. The method according to claim 10, further comprising the step of providing the identification label with a brand logo.

12. The method according to claim 10, further comprising the step of providing the identification label with a product location within a store where the product package can be located within the store.

13. (canceled)

14. (canceled)

15. The method according to claim 10, further comprising the step of providing the identification label with a product name.

16. The method according to claim 10, further comprising the step of providing the release layer secured to an outside surface of the product package.

17. The method according to claim 10, further comprising the step of providing the release layer secured to an inside surface of the product package.

18. The method according to claim 10, further comprising the step of providing the savings coupon with perforations for separating the savings coupon from the identification label.

19. A method for creating a shopping list comprising steps of:
providing a product package;
providing a release layer secured to a surface of the product package;
providing an identification label having a layer of adhesive adhered to the release layer to removably secure the identification label to the product package;
providing the identification label with product identification information including a brand logo, a brand name, a product name, a product identification number, and a bar code representing the product identification number; and
whereby a consumer obtains the product package, removes the identification label from the release layer, adheres the identification label to a shopping list to form a list of products to purchase, goes to a store to obtain an additional product package, and uses the identification label adhered to the shopping list to locate the additional product package within the store.

20. (canceled)

21. The method according to claim 10, further comprising the consumer ordering the additional product package using the electronic shopping list.

22. The method according to claim 10, wherein the electronic shopping list includes a product location within a store where the additional product package can be located within the store.

23. The method according to claim 19, wherein the consumer uses the bar code on the identification label adhered to the shopping list to locate the additional product package within the store.
